(19) United States
(12) Patent Application Publication
(10) Pub. No.: US 2025/0017710 A1
(43) Pub. Date: Jan. 16, 2025

(54) BIDIRECTIONAL MAGNETIC LEVITATION BRUSH MOTOR DEVICE

(71) Applicant: CREATIVE MOTOR TECHNOLOGY (DONGGUAN) CO., LTD., Dongguan (CN)

(72) Inventors: Min DENG, Yongzhou (CN); Mu YAN, Xiaogan (CN)

(73) Assignee: CREATIVE MOTOR TECHNOLOGY (DONGGUAN) CO., LTD., Dongguan (CN)

(21) Appl. No.: 18/352,208

(22) Filed: Jul. 13, 2023

(51) Int. Cl. A61C 17/34; H02K 1/2733; H02K 33/12

(52) U.S. Cl. CPC A61C 17/3472; H02K 1/2733; H02K 33/12; A61C 17/3436; A61C 17/3445

(57) ABSTRACT

Disclosed herein is a bidirectional magnetic levitation brush motor device, including a motor housing, a motor shaft and an end cover, wherein the end cover is arranged at a bottom end of the motor housing, shaft holes are formed in axes of the motor housing and the end cover, the motor shaft is arranged between the two shaft holes, bearings are arranged at junctions of the motor shaft with the motor housing and the end cover, the end of the motor shaft that is away from the end cover extends out of the motor housing, and a transmission connection shaft is arranged at a top end of the motor shaft. With regard to the present invention, movement transmission is achieved by means of an electromagnetic effect, and mounting of elastic structures such as a torsion bar and the like is no longer needed.

### TECHNICAL FIELD

The present invention relates to the technical field of motors, in particular to a bidirectional magnetic levitation brush motor device.

### BACKGROUND

With the continuous improvement of people's living standards, electric toothbrushes begun to appear in the daily life of people to replace traditional toothbrushes to achieve the more ideal and more convenient tooth brushing effects.

The existing electric toothbrushes are usually driven by motors and achieve the tooth cleaning effect through vibration of toothbrush heads. The motors of the existing electric toothbrushes are generally required to be provided with springs or torsion bars like torsional springs, and such structures are prone to damage and are not easy to repair during usage, so that the service lives of the motors often depend on the service time of the above-mentioned structures. In addition, with the adoption of the above-mentioned structural design, the bearing capacity of the motors is low, the torque that can be transmitted by the motors in the unit volume is small, changes of the amplitudes of swing of motor shafts are large when different loads are borne, and the use effect is not stable enough.

Besides, the existing electric toothbrushes generally have the movement loci of radially left and right swinging and do not have the axial telescoping function. However, during tooth brushing in the daily life, people need to clean their teeth by vertical swinging (radial swinging) and also need left and right movements (axial telescoping) to achieve the purpose of all-around cleaning, and the safety protection of the motors of the electric toothbrushes need to be further enhanced.

Therefore, it is necessary to invent a bidirectional magnetic levitation brush motor device so as to solve the above-mentioned problem.

### SUMMARY

The present invention aims to provide a bidirectional magnetic levitation brush motor device. Movement transmission is achieved by means of an electromagnetic effect, and mounting of elastic structures such as a torsion bar and the like is no longer needed, so that on one hand, the situation that the service life of a motor is short due to the fact that the elastic structures are prone to damage during usage is avoided, and on the other hand, the motor in a unit volume can transmit torque in a larger value. A transmission medium is provided by a combination of a commutator and electric brush needles to achieve the purpose of all-around cleaning and the safety effect, thereby solving the above-mentioned defects in the prior art.

In order to achieve the above purposes, the present invention provides the following technical solution: the bidirectional magnetic levitation brush motor device comprises a motor housing, a motor shaft and an end cover, wherein the end cover is arranged at a bottom end of the motor housing, shaft holes are formed in axes of the motor housing and the end cover, the motor shaft is arranged between the two shaft holes, bearings are arranged at junctions of the motor shaft with the motor housing and the end cover, the end of the motor shaft that is away from the end cover extends out of the motor housing, a transmission connection shaft is arranged at a top end of the motor shaft, an insulated protective shell is arranged on the side of the end cover that is away from the motor housing, a commutator is sleeved on an outer side of a bottom of the motor shaft, two symmetrically distributed electric brush needles are arranged on two sides of a bottom of the commutator, each of the electric brush needles has an L-shaped section, a top end and a bottom end of each of the electric brush needles are respectively connected to the commutator and the end cover in an inserted manner, a transmission unit is arranged inside the motor housing, the transmission unit comprises a stator assembly and a rotor assembly, and the rotor assembly is arranged inside the stator assembly;
the stator assembly comprises a stator framework and magnetic steel, placing grooves are formed in two sides of the stator framework, the magnetic steel is arranged inside the placing grooves, and limiting frames are arranged on two sides of an inner wall of the stator framework;
the rotor assembly comprises a rotor core and coil windings, the rotor core is arranged on an outer side of the motor shaft in an overlying manner, the rotor core comprises rotor teeth and pole shoes, the rotor teeth and the pole shoes are arranged integrally, and the coil windings are wound around outer sides of the rotor teeth; and
four placing grooves are formed, the four placing grooves are symmetrically distributed about a bisector of the rotor core, the spacing angles among the four placing grooves are unequal, the four pieces of magnetic steel are distributed in a height staggered manner, every two adjacent pieces of magnetic steel have unequal heights, self-attraction surfaces and non-self-attraction surfaces are formed by the magnetic steel and the rotor core, and areas of the self-attraction surfaces are greater than areas of the non-self-attraction surfaces.

Preferably, the motor shaft and the transmission connection shaft are arranged coaxially, an inserting groove is formed at a bottom end of the transmission connection shaft, the top end of the motor shaft is arranged inside the inserting groove, and the motor shaft is in transmission connection with the transmission connection shaft.

Preferably, one or more transmission units are arranged, and one or more preset values of a plurality of the transmission units are set.

Preferably, the motor housing has a flat or circular section, both the end cover and the stator framework match with an inner contour of the motor housing, the end cover is connected to the motor housing in a riveted manner, and the rotor core matches with the inner wall of the stator framework.

Preferably, the coil windings have identical winding directions on the rotor teeth; the two transmission units are electrically connected by means of coil taps; tap lines of the four coil windings are respectively set as a first coil, a second coil, a third coil and a fourth coil, a head of the first coil is connected to a tail of the second coil, a head of the third coil is connected to a tail of the fourth coil, a head of the second coil and a head of the fourth coil are connected on one side of the commutator, commutator segments are arranged on two sides of a top end of the commutator, and a tail of the first coil and a tail of the third coil are connected to the commutator segments of the commutator.

Preferably, coil winding wires of the coil windings are respectively set as upper and lower windings and left and right windings, the upper and lower windings have identical magnetic fields after being electrified, and the left and right windings have opposite magnetic fields after being electrified.

Preferably, the four pieces of magnetic steel in the transmission unit are divided into two groups, two pieces of magnetic steel are arranged in each group, the two pieces of magnetic steel in each group have opposite polarities, and the two groups of magnetic steel have correspondingly identical upper and lower polarities.

Preferably, the electric brush needles are electrically connected to an external power supply, and the electric brush needles are electrically connected to the coil windings by means of the commutator.

Preferably, a surface of the rotor core is coated with 3M insulating powder.

In the above-mentioned technical solutions, the present invention has the technical effects and advantages as follows:
the movement transmission is achieved by means of the electromagnetic effect, and mounting of the elastic structures such as the torsion bar and the like is no longer needed, so that on one hand, the situation that the service life of the motor is short due to the fact that the elastic structures are prone to damage during usage is avoided, and on the other hand, the motor in a unit volume can transmit torque in a larger value; the transmission medium is provided by the combination of the commutator and the electric brush needles to introduce a current of an external circuit to the rotor coil windings to generate the magnetic field, and thus the working stability is high; and compared with the prior art, an electric toothbrush can rotate axially and radially at the same time for tooth brushing, and the gap that electric toothbrushes cannot telescope axially apart from radially swinging left and right in the market is filled.

### BRIEF DESCRIPTION OF DRAWINGS

In order to explain the technical solutions in embodiments of the present application or the prior art more clearly, drawings needed by the embodiments will be briefly introduced below. Obviously, the drawings in the following descriptions are only some embodiments recited in the present invention, and for those of ordinary skill in the art, other drawings can be obtained according to these drawings.

FIG. 1 is an exploded view of an overall structure of the present invention;

FIG. 2 is a schematic diagram of the overall structure of the present invention;

FIG. 3 is a right side view of the present invention;

FIG. 4 is a schematic diagram of an A-A′ sectional structure in FIG. 3 of the present invention;

FIG. 5 is a front view of the present invention;

FIG. 6 is a schematic diagram of a B-B′ sectional structure in FIG. 5 of the present invention;

FIG. 7 is a structure schematic diagram of a rotor core of the present invention;

FIG. 8 is a schematic diagram of an internal structure of a motor of the present invention;

FIG. 9 is a schematic diagram of a C-C′ sectional structure in FIG. 8 of the present invention;

FIG. 10 is a schematic diagram of a D-D′ sectional structure in FIG. 8 of the present invention;

FIG. 11 is a front view of a distribution structure of self-attraction surfaces and non-self-attraction surfaces of the present invention;

FIG. 12 is a left side view of the distribution structure of the self-attraction surfaces and the non-self-attraction surfaces of the present invention;

FIG. 13 is a left side view of a polarity distribution structure of magnetic steel of the present invention;

FIG. 14 is a front view of the polarity distribution structure of the magnetic steel of the present invention; and

FIG. 15 is a schematic diagram of a distribution structure of the magnetic steel of the present invention.

### DESCRIPTION OF REFERENCE NUMERALS

1 motor housing, 2 motor shaft, 3 end cover, 4 bearing, 5 transmission connection shaft, 6 insulated protective shell, 7 commutator, 8 electric brush needle, 9 stator assembly, 10 rotor assembly, 11 stator framework, 12 magnetic steel, 121 self-attraction surface, 122 non-self-attraction surface, 13 placing groove, 14 limiting frame, 15 rotor core, 151 rotor tooth, 152 pole shoe, 16 coil winding, 161 first coil, 162 second coil, 163 third coil, and 164 fourth coil.

### DETAILED DESCRIPTION OF THE EMBODIMENTS

The present invention is further described in detail in conjunction with the accompanying drawings below, so that those skilled in the art can better understand the technical solutions of the present invention.

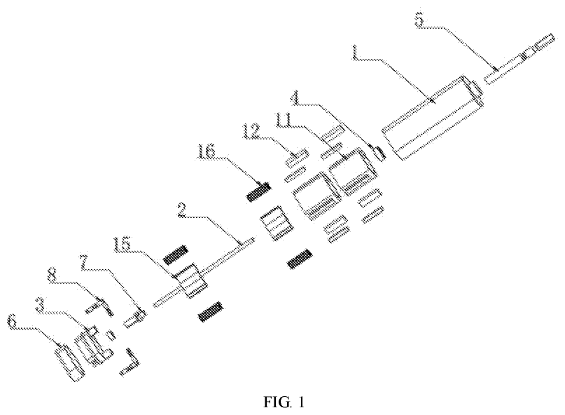

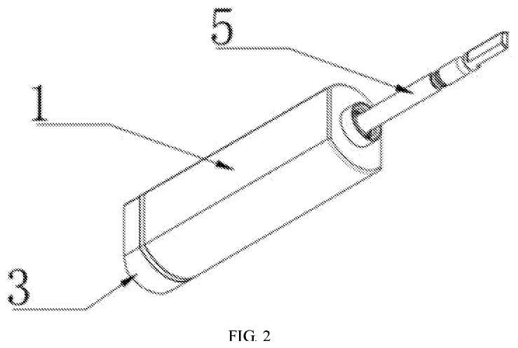

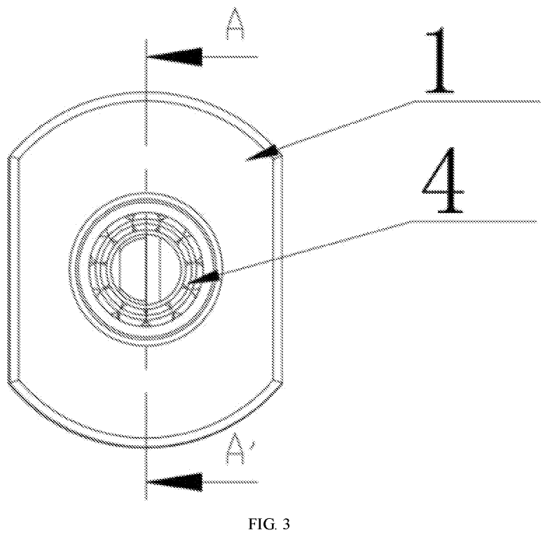

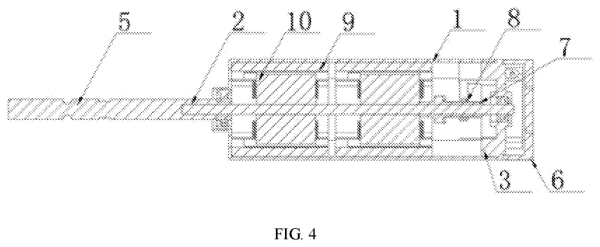

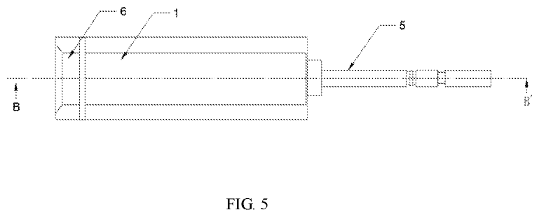

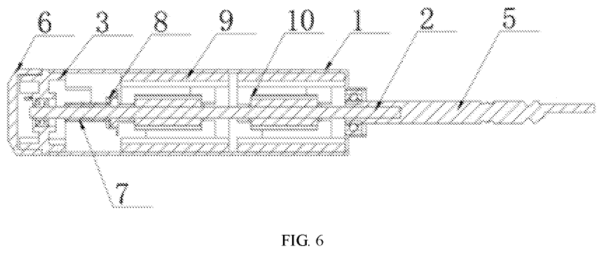

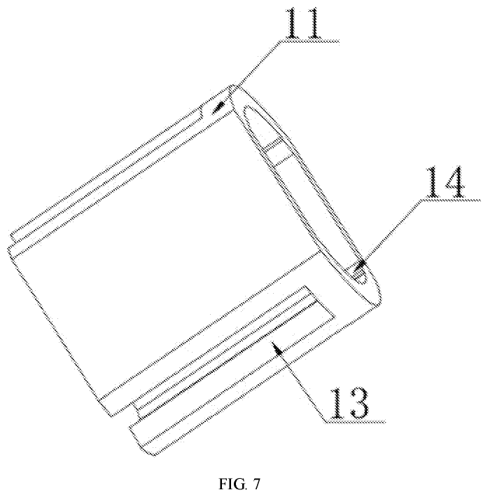

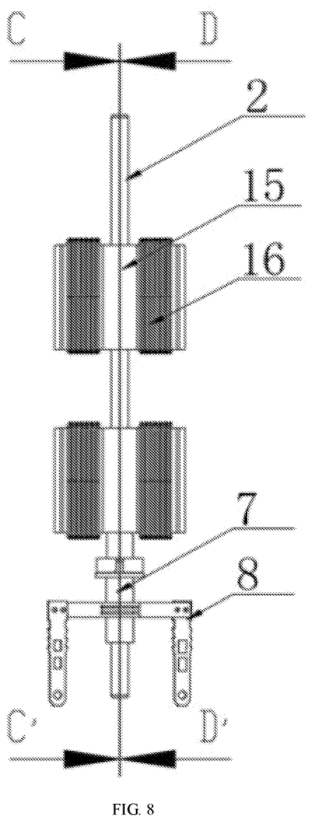

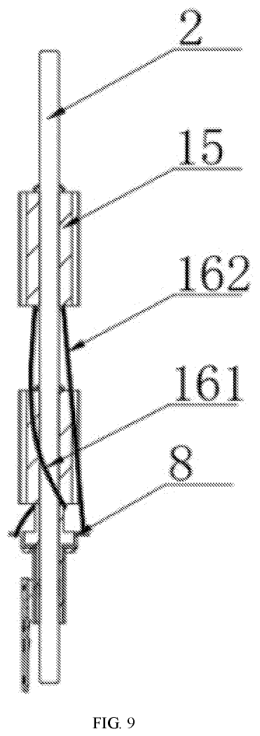

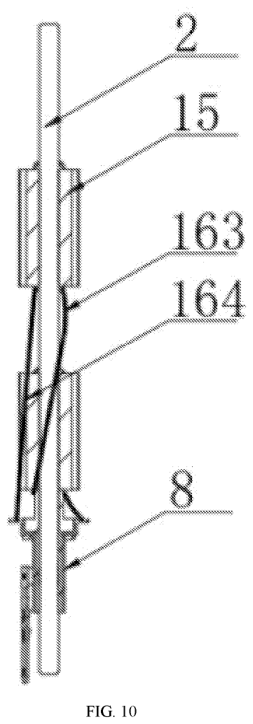

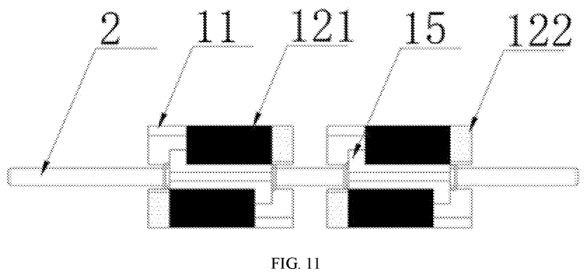

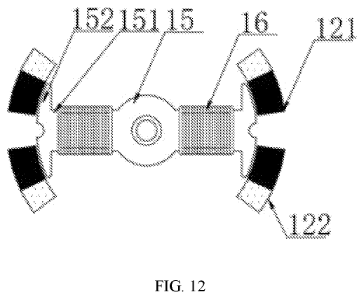

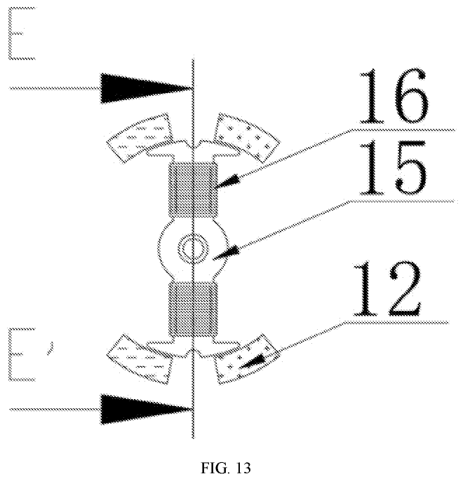

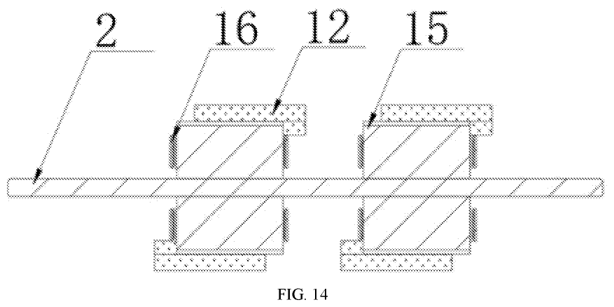

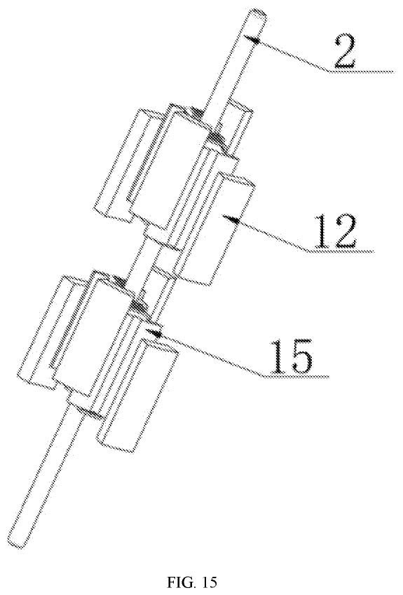

The present invention provides a bidirectional magnetic levitation brush motor device as shown in FIGS. 1-15, comprising a motor housing 1, a motor shaft 2 and an end cover 3, wherein the end cover 3 is arranged at a bottom end of the motor housing 1, shaft holes are formed in axes of the motor housing 1 and the end cover 3, the motor shaft 2 is arranged between the two shaft holes, bearings 4 are arranged at junctions of the motor shaft 2 with the motor housing 1 and the end cover 3, the end of the motor shaft 2 that is away from the end cover 3 extends out of the motor housing 1, a transmission connection shaft 5 is arranged at a top end of the motor shaft 2, an insulated protective shell 6 is arranged on the side of the end cover 3 that is away from the motor housing 1, a commutator 7 is sleeved on an outer side of a bottom of the motor shaft 2, two symmetrically distributed electric brush needles 8 are arranged on two sides of a bottom of the commutator 7, each of the electric brush needles 8 has an L-shaped section, a top end and a bottom end of each of the electric brush needles 8 are respectively connected to the commutator 7 and the end cover 3 in an inserted manner, a transmission unit is arranged inside the motor housing 1, the transmission unit comprises a stator assembly 9 and a rotor assembly 10, and the rotor assembly 10 is arranged inside the stator assembly 9;
the stator assembly 9 comprises a stator framework 11 and magnetic steel 12, placing grooves 13 are formed in two sides of the stator framework 11, the magnetic steel 12 is arranged inside the placing grooves 13, and limiting frames 14 are arranged on two sides of an inner wall of the stator framework 11;
the rotor assembly 10 comprises a rotor core 15 and coil windings 16, the rotor core 15 is arranged on an outer side of the motor shaft 2 in an overlying manner, the rotor core 15 comprises rotor teeth 151 and pole shoes 152, the rotor teeth 151 and the pole shoes 152 are arranged integrally, and the coil windings 16 are wound around outer sides of the rotor teeth 151;
four placing grooves 13 are formed, the four placing grooves 13 are symmetrically distributed about a bisector of the rotor core 15, the spacing angles among the four placing grooves 13 are unequal, the four pieces of magnetic steel 12 are distributed in a height staggered manner, every two adjacent pieces of magnetic steel 12 have unequal heights, self-attraction surfaces 121 and non-self-attraction surfaces 122 are formed by the magnetic steel 12 and the rotor core 15, and areas of the self-attraction surfaces 121 are greater than areas of the non-self-attraction surfaces 122; and
a medium is provided by a combination of the commutator 7 and the electric brush needles 8 to introduce a current of an external circuit to the rotor coil windings to generate magnetic fields.

Further, in the above-mentioned technical solution, the motor shaft 2 and the transmission connection shaft 5 are arranged coaxially, the inserting groove is formed at the bottom end of the transmission connection shaft 5, the top end of the motor shaft 2 is arranged inside the inserting groove, and the motor shaft 2 is in transmission connection with the transmission connection shaft 5, so that on one hand, the shaft processing precision is improved, on the other hand, the production efficiency can be improved, all that is needed is to change different output shafts for different customers, and motors can be stocked and are easy to standardize.

Further, in the above-mentioned technical solution, one or more transmission units are arranged, and one or more preset values of a plurality of the transmission units are set.

Further, in the above-mentioned technical solution, the motor housing 1 has a flat or circular section, both the end cover 3 and the stator framework 11 match with an inner contour of the motor housing 1, the end cover 3 is connected to the motor housing 1 in a riveted manner, the rotor core 15 matches with the inner wall of the stator framework 11, the insulated protective shell 6 can protect the electric brush needles 8 against deformation, wires are covered after being welded, then connecting wires are led out, and the insulating purpose is also achieved.

Further, in the above-mentioned technical solution, the coil windings 16 have identical winding directions on the rotor teeth 151; the two transmission units are electrically connected by means of coil taps; tap lines of the four coil windings 16 are respectively set as a first coil 161, a second coil 162, a third coil 163 and a fourth coil 164, a head of the first coil 161 is connected to a tail of the second coil 162, a head of the third coil 163 is connected to a tail of the fourth coil 164, a head of the second coil 162 and a head of the fourth coil 164 are connected on one side of the commutator 7, commutator segments are arranged on two sides of a top end of the commutator 7, and a tail of the first coil 161 and a tail of the third coil 163 are connected to the commutator segments of the commutator 7.

Further, in the above-mentioned technical solution, coil winding wires of the coil windings 16 are respectively set as upper and lower windings and left and right windings, the upper and lower windings have identical magnetic fields after being electrified, and the left and right windings have opposite magnetic fields after being electrified.

Further, in the above-mentioned technical solution, the four pieces of magnetic steel 12 in the transmission unit are divided into two groups, two pieces of magnetic steel 12 are arranged in each group, the two pieces of magnetic steel 12 in each group have opposite polarities, and the two groups of magnetic steel 12 have correspondingly identical upper and lower polarities;

in a radial direction, the magnetic steel is attracted by the rotor teeth, and the areas of the self-attraction surfaces are greater than the areas of the non-self-attraction surface, so that levitation in the radial direction can be achieved; in an axial direction, the magnetic steel is attracted by the rotor core, and the areas of the self-attraction surfaces are greater than the areas of the non-self-attraction surface, so that levitation in the axial direction can be achieved; in the radial direction, even if a rotor deflects to the maximum position angle, the areas of the self-attraction surfaces are still greater than the areas of the non-self-attraction surface; and in the axial direction, even if the rotor axially shifts to the maximum position, the areas of the self-attraction surfaces are still greater than the areas of the non-self-attraction surface.

Further, in the above-mentioned technical solution, the electric brush needles 8 are electrically connected to an external power supply, and the electric brush needles 8 are electrically connected to the coil windings 16 by means of the commutator 7.

Further, in the above-mentioned technical solution, a surface of the rotor core 15 is coated with 3M insulating powder which plays an insulating role between the coil windings 16 and the rotor core 15.

The bottom end of the motor housing 1 is sealed through riveting of the end cover 3 and achieves insulated protection in cooperation with the insulated protective shell 6, the bearings 4 are used to form a bidirectional magnetic levitation motor structure relative to the stator assembly 9, thus the motor shaft 2 rotates more smoothly, wear of the motor shaft 2 is avoided, and meanwhile, the position of the motor shaft 2 can also be stabilized; at the same time, front and rear ends of the motor shaft 2 can be stressed more uniformly by means of a pair of bearings 4, and stable mounting is achieved, so that on one hand, supporting positions are provided for the motor shaft 2, compact mounting of the stator assembly 9 and the rotor assembly 10 is facilitated, stable matching is achieved, on the other hand, the stator assembly 9 and the rotor assembly 10 inside can also be protected against the pollution and influence of an external environment as much as possible, and continuous and stable power transmission of the motor shaft 2 can be ensured.

The specific embodiment is as follows: during actual usage of the device, the external current is guided by the commutator 7 and the electric brush needles 8 to electrify the coil windings 16 to form magnetic fields at the rotor core 15, the magnetic steel 12 is located in the range of the magnetic fields, the preset values are provided in the radial direction and in the axial direction, the magnetic steel interact with each other, stators of the same polarity push the anisotropic magnetic steel 12, the magnetic steel 12 of the same polarity is subjected to acting forces of magnetic fields of anisotropic stators, and thus the magnetic steel 12 pushes the rotor core 15 to reciprocate vertically while rotating; the rotor core 15 is fixedly connected to the motor shaft 2 and then drives the motor shaft 2 to reciprocate vertically while rotating, the coil windings 16 switch a current direction and control the electrification time by means of an external circuit, thus rotors reciprocate left and right and up and down, and the movement of the rotor assembly 10 corresponds to the movement of the motor shaft 2; movement transmission is achieved by means of an electromagnetic effect, and mounting of elastic structures such as a torsion bar and the like is no longer needed, so that on one hand, the situation that the service life of a motor is short due to the fact that the elastic structures are prone to damage during usage is avoided, on the other hand, the motor in a unit volume can transmit torque in a larger value, and the volume of the motor can be minimized when the rated torque is reached; when the device is applied to an electric toothbrush, the weight of the electric toothbrush can be reduced, the electric toothbrush telescopes vertically while swinging left and right, which is closer to the feeling of brushing teeth in daily life, and the cleaning effect is greatly improved; power is transmitted by means of an electromagnetic structure, and thus the power transmission process is more stable; and a transmission medium is provided by a combination of the commutator 7 and the electric brush needles 8 to introduce the current of the external circuit to the rotor coil windings to generate the magnetic fields, and thus the working stability is high.

The working principle of the present invention is as follows:
reference is made to FIGS. 1-14 of the specification, the coil windings 16 are electrified to form the magnetic fields at the rotor core 15, the magnetic steel 12 is located in the range of the magnetic fields, the preset values are provided in the radial direction and in the axial direction, the magnetic steel interacts with each other, the stators of the same polarity push the anisotropic magnetic steel 12, the magnetic steel 12 of the same polarity is subjected to the acting forces of the magnetic fields of the anisotropic stators, and thus the magnetic steel 12 pushes the rotor core 15 to reciprocate vertically while rotating; the rotor core 15 is fixedly connected to the motor shaft 2 and then drives the motor shaft 2 to reciprocate vertically while swinging left and right, the coil windings 16 switch the current direction and control the electrification time by means of the external circuit, thus the rotors reciprocate left and right and up and down, and the movement of the rotor assembly 10 corresponds to the movement of the motor shaft 2; and the movement transmission is achieved by means of the electromagnetic effect, and mounting of the elastic structures such as the torsion bar and the like is no longer needed, so that on one hand, the situation that the service life of the motor is short due to the fact that the elastic structures are prone to damage during usage is avoided, and on the other hand, the motor in a unit volume can transmit torque in a larger value.

Some exemplary embodiments of the present invention are described in an illustrative manner above. There is no doubt about that for those of ordinary skill in the art, the described embodiments can be amended in different manners without departing from the spirit and the scope of the present invention. Therefore, the drawings and descriptions above are illustrative in essence, and should not be understood as limitations on the scope of protection of the claims of the present invention.

What is claimed is:

1. A bidirectional magnetic levitation brush motor device, comprising a motor housing, a motor shaft and an end cover, wherein the end cover is arranged at a bottom end of the motor housing, shaft holes are formed in axes of the motor housing and the end cover, the motor shaft is arranged between the two shaft holes, bearings are arranged at junctions of the motor shaft with the motor housing and the end cover, the end of the motor shaft that is away from the end cover extends out of the motor housing, a transmission connection shaft is arranged at a top end of the motor shaft, an insulated protective shell is arranged on the side of the end cover that is away from the motor housing, a commutator is sleeved on an outer side of a bottom of the motor shaft, two symmetrically distributed electric brush needles are arranged on two sides of a bottom of the commutator, each of the electric brush needles has an L-shaped section, a top end and a bottom end of each of the electric brush needles are respectively connected to the commutator and the end cover in an inserted manner, a transmission unit is arranged inside the motor housing, the transmission unit comprises a stator assembly and a rotor assembly, and the rotor assembly is arranged inside the stator assembly;
the stator assembly comprises a stator framework and magnetic steel, placing grooves are formed in two sides of the stator framework, the magnetic steel is arranged inside the placing grooves, and limiting frames are arranged on two sides of an inner wall of the stator framework;
the rotor assembly comprises a rotor core and coil windings, the rotor core is arranged on an outer side of the motor shaft in an overlying manner, the rotor core comprises rotor teeth and pole shoes, the rotor teeth and the pole shoes are arranged integrally, and the coil windings are wound around outer sides of the rotor teeth; and
four placing grooves are formed, the four placing grooves are symmetrically distributed about a bisector of the rotor core, the spacing angles among the four placing grooves are unequal, the four pieces of magnetic steel are distributed in a height staggered manner, every two adjacent pieces of magnetic steel have unequal heights, self-attraction surfaces and non-self-attraction surfaces are formed by the magnetic steel and the rotor core, and areas of the self-attraction surfaces are greater than areas of the non-self-attraction surfaces.

2. The bidirectional magnetic levitation brush motor device according to claim 1, wherein the motor shaft and the transmission connection shaft are arranged coaxially, an inserting groove is formed at a bottom end of the transmission connection shaft, the top end of the motor shaft is arranged inside the inserting groove, and the motor shaft is in transmission connection with the transmission connection shaft.

3. The bidirectional magnetic levitation brush motor device according to claim 1, wherein one or more transmission units are arranged, and one or more preset values of a plurality of the transmission units are set.

4. The bidirectional magnetic levitation brush motor device according to claim 1, wherein the motor housing has a flat or circular section, both the end cover and the stator framework match with an inner contour of the motor housing, the end cover is connected to the motor housing in a riveted manner, and the rotor core matches with the inner wall of the stator framework.

5. The bidirectional magnetic levitation brush motor device according to claim 1, wherein the coil windings have identical winding directions on the rotor teeth; the two transmission units are electrically connected by means of coil taps; tap lines of the four coil windings are respectively set as a first coil, a second coil, a third coil and a fourth coil, a head of the first coil is connected to a tail of the second coil, a head of the third coil is connected to a tail of the fourth coil, a head of the second coil and a head of the fourth coil are connected on one side of the commutator, commutator segments are arranged on two sides of a top end of the commutator, and a tail of the first coil and a tail of the third coil are connected to the commutator segments of the commutator.

6. The bidirectional magnetic levitation brush motor device according to claim 1, wherein coil winding wires of the coil windings are respectively set as upper and lower windings and left and right windings, the upper and lower windings have identical magnetic fields after being electrified, and the left and right windings have opposite magnetic fields after being electrified.

7. The bidirectional magnetic levitation brush motor device according to claim 1, wherein the four pieces of magnetic steel in the transmission unit are divided into two groups, two pieces of magnetic steel are arranged in each group, the two pieces of magnetic steel in each group have opposite polarities, and the two groups of magnetic steel have correspondingly identical upper and lower polarities.

8. The bidirectional magnetic levitation brush motor device according to claim 1, wherein the electric brush needles are electrically connected to an external power supply, and the electric brush needles are electrically connected to the coil windings by means of the commutator.

9. The bidirectional magnetic levitation brush motor device according to claim 1, wherein a surface of the rotor core is coated with 3M insulating powder.
